(19) United States
(12) Patent Application Publication
(10) Pub. No.: US 2005/0013263 A1
(43) Pub. Date: Jan. 20, 2005

(54) Apparatus and method for transmitting/receiving uplink data retransmission request in a CDMA communication system

(75) Inventors: Young-Bum Kim, Seoul (KR); Ju-Ho Lee, Suwon-si (KR); Sung-Ho Choi, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/751,071

(22) Filed: Jan. 2, 2004

(30) Foreign Application Priority Data
Jan. 4, 2003 (KR) 2003-462

(51) Int. Cl. H04B 7/216

(52) U.S. Cl. 370/320; 370/335; 370/342; 370/441; 370/473; 714/748

(57) ABSTRACT

Disclosed is a code division multiple access (CDMA) communication system having a downlink dedicated physical channel (DL_DPCH) having a downlink dedicated physical control channel (DL_DPCCH) and a downlink dedicated physical data channel (DL_DPDCH). The DL_DPCCH having a transport power control (TPC) field transmitting a TPC command for controlling uplink transport power, a transport format combination indicator (TFCI) field transmitting TFCI indicating a transport format combination of a currently transmitted channel, and a pilot field transmitting a pilot. The DL_DPDCH has first and second data fields transmitting downlink data. If data is normally received over an enhanced uplink dedicated channel (EUDCH), ACK information is generated, and if data is abnormally received over the EUDCH, NACK information is generated. Bits corresponding to the ACK or NACK information are punctured at a position randomly selected from the first and second data fields of the DL_DPDCH, and the ACK or NACK information is inserted into the punctured position before being transmitted.

### PRIORITY

This application claims priority under 35 U.S.C. § 119 to an application entitled “Apparatus and Method for Transmitting/Receiving Uplink Data Retransmission Request in a CDMA Communication System” filed in the Korean Intellectual Property Office on Jan. 4, 2003 and assigned Serial No. 2003-462, the contents of which are incorporated herein by reference.

### BACKGROUND OF THE INVENTION

1. Field of the Invention

The present invention relates generally to a CDMA communication system, and in particular, to an apparatus and method for transmitting/receiving an uplink data retransmission request.

2. Description of the Related Art

In general, owing to the development of communication technology, CDMA (Code Division Multiple Access) has evolved into a system that enables high-speed packet data transmission. Such a communication system is commonly referred to as HSDPA (High-Speed Downlink Packet Access). HSDPA generically refers to a data transmission scheme involving a high-speed downlink shared channel (HS-DSCH) supporting high-speed downlink packet transmission, and its related control channels in a UMTS (Universal Mobile Telecommunication System) developed in Europe. To support HSDPA, AMC (Adaptive Modulation and Coding), HARQ (Hybrid Automatic Retransmission Request), and FCS (Fast Cell Select) were proposed. With reference to FIG. 1, the architecture of a WCDMA (Wideband Code Division Multiple Access) or UMTS communication system will be described below.

FIG. 1 is a block diagram illustrating the configuration of a typical WCDMA communication system.

The WCDMA communication system comprises a core network (CN) 100, a plurality of RNSs (Radio Network Subsystems) 110 and 120, and a UE (User Equipment) 130. Each of the RNSs 110 and 120 includes an RNC (Radio Network Controller) and a plurality of Node Bs (Node B and cell are used interchangeably, hereinafter). For example, the RNS 110 includes an RNC 111 and Node Bs 113 and 115, whereas the RNS 120 includes an RNC 112 and Node Bs 114 and 116. There are three types of RNCs, a serving RNC (SRNC), a drift RNC (DRNC) and a controlling RNC (CRNC) according to their functions. The SRNC is distinguished from the DRNC according to their roles as relating to a UE. The SRNC is responsible for managing information related to the UE and data transmission between the UE and a CN (Core Network). If the UE transmits/receives data to/from the SRNC via an RNC which is not currently serving the UE, this RNC is the DRNC. An RNC controlling a Node B is a CRNC for the Node B. In the case illustrated in FIG. 1, if the RNC 111 manages information related to UE 130, it is the SRNC for the UE 130. As the UE 130 moves and transmits/receives data through the RNC 112, the RNC 112 is the DRNC for the UE 130. The RNC 111, which controls the Node B 113, is the CRNC for the Node B 113.

With reference to FIG. 1, HARQ, particularly n-channel SAW HARQ (n-channel Stop And Wait Hybrid Automatic Retransmission Request) will be described.

With regard to the n-channel SAW HARQ, two new schemes were introduced to increase the efficiency of SAW ARQ (Stop And Wait Automatic Retransmission Request).

One of the new schemes is soft combining. Soft combining is a scheme in which a receiver temporarily stores defective data and combines a retransmitted version of the data with the stored data in order to reduce error probability. There are two soft combining methods: chase combining (CC) and incremental redundancy (IR).

In the CC method, a transmitter adopts the same format at both an initial transmission and a retransmission. If m symbols are transmitted in one coded block at an initial transmission, the same m symbols are transmitted at a retransmission. The coded block is a unit of user data transmitted for one TTI (Transmit Time Interval). The same coding rate applies to both the initial transmission and the retransmission. The receiver then combines the initially transmitted coded block with the retransmitted coded block, checks the CRC (Cyclic Redundancy Check) of the combined coded block, and determines if there are errors in the combined coded block.

The IR method uses different formats at an initial transmission and a retransmission. If m symbols are generated from n-bit user data after channel coding, the transmitter transmits part of the m symbols at an initial transmission and sequentially transmits the remaining symbols at a retransmission. Different coding rates apply to the initial transmission and the retransmission. The receiver then produces a coded block with a high coding rate by attaching the retransmitted coded block to the initially transmitted coded block, and corrects errors in the coded block. In the IR scheme, an initial transmission and retransmissions are identified by their version numbers. The initial transmission is numbered 1, a first retransmission is numbered 2, and the following retransmission is numbered 3. By using this version information, the receiver can correctly combine the initially coded block with any retransmitted coded blocks.

The IR method is implemented in either a self-decodable or a non-self-decodable format. Self-decodable and partial IR are interchangeably used, whereas non-self-decodable and full IR are interchangeably used. Hereinafter, the terms, partial IR and full IR will mainly be used. The partial IR uses a part of an initial transmission format at a retransmission. This part of the initial transmission format is the systematic part of a turbo code. The systematic part enables self-decoding. If the partial IR is adopted, the receiver can decode received data without combining buffered initially transmitted data with retransmitted data. On the other hand, the full IR uses different formats at an initial transmission and a retransmission, to thereby maximize redundancy information-incurred gain. Because a systematic part is not included in retransmitted data in the full IR, it is impossible to decode received data with retransmitted data. Therefore, the receiver can decode the received data normally only if it combines the initially transmitted data with the retransmitted data.

The other scheme of increasing the efficiency of the n-channel SAW HARQ is HARQ.

In a general SAW HARQ, a Node B transmits the current packet only when it receives an acknowledgement (ACK) of the receipt of the previously transmitted packet. Thus, it may occur that even when the Node B can transmit the current packet, the Node B must wait for the ACK. The n-channel SAW HARQ allows transmission of successive packets without receiving an ACK about a previously transmitted packet, thereby increasing the use efficiency of a radio link. In the n-channel SAW HARQ, n logical channels are established between a Node B and a UE. The UE determines upon which channel a packet received at a particular time point is mapped by identifying the n logical channels by predetermined time points or explicit channel numbers assigned to them. The UE must rearrange packets in the correct order, or soft-combine the packets. The n-channel SAW HARQ will be described in more detail referring to FIG. 1. It is assumed herein that the n-channel SAW HARQ, particularly a 4-channel SAW HARQ is implemented between the UE 130 and the Node B 114 and logical IDs 1 to 4 are assigned to the four channels. The UE 130 and the Node B 114 are each provided with an HARQ processor for each channel in the physical layer. The Node B 114 assigns channel ID 1 to an initial transmission coded block and transmits the coded block to the UE 130. The channel ID can be explicitly assigned, or implicitly assigned as a predetermined time point. If the coded block with channel ID 1 has errors, the UE 130 provides the coded block to an HARQ processor for channel ID 1, namely HARQ processor 1, and transmits a non-acknowledgement (NACK) about channel 1 to the Node B 114. The Node B 114 can transmit the next coded block on channel 2 irrespective of whether it has received an ACK about the coded block on channel 1. If the next coded block also has errors, the Node B 114 also transmits the next coded block to a corresponding HARQ processor. Upon receipt of the NACK about the coded block on channel 1 from the UE 130, the Node B retransmits the coded block on channel 1. The UE 130 recognizes that the received coded block is a retransmitted version of the previous coded block received on channel 1 and transmits the retransmitted coded block to HARQ processor 1. HARQ processor 1 soft-combines the initially transmitted coded block with the retransmitted coded block. As described above, the n-channel SAW HARQ matches a channel ID to an HARQ processor on a one-to-one correspondence. Without delaying transmission of user data until an ACK is received, an initial transmission and retransmissions can be appropriately matched.

As described above, the process of determining if received data has errors and correspondingly transmitting an ACK/NACK in the receiver is quite significant to efficiently support the HARQ scheme. The transmitter determines whether to retransmit the data according to the ACK/NACK. In HSDPA, an uplink HS-DPCCH (High Speed-Dedicated Physical Control Channel) delivers an ACK/NACK about data transmitted by a transmitter or a Node B. With respect to the HS-DPCCH, if an uplink control channel slot format used for a non-HSDPA communication system, for example, Release-99, is modified to deliver an ACK/NACK, compatibility with the Release-99 communication system is not ensured and an uplink channel structure becomes complex. Thus, the HS-DPCCH is defined using a novel channelization code.

Control information delivered on the HS-DPCCH includes ACK/NACK and CQI (Channel Quality Indicator). The ACK/NACK can be expressed in one bit. As to the CQI, upon receipt of a downlink channel signal, a UE measures channel quality from the downlink channel signal and transmits a CQI representing the channel quality to a Node B. The Node B determines an MCS (Modulation and Coding Scheme) level for the HS-DSCH according to the channel quality and generates a TFRI (Transport Format and Resource Related Information) as control information about the HS-DSCH. For example, if the CQI indicates a good channel condition, the Node B selects a modulation that exhibits a high BER (Bit Error Rate) but allows a high data rate, such as 16-QAM (Quadrature Amplitude Modulation). On the contrary, if the CQI indicates a poor channel condition, the Node B selects a relatively reliable modulation such as QPSK (Quadrature Phase Shift Keying). The ACK/NACK and CQI are delivered over the HS-DPCCH. If the HS-DPCCH has a 3-slot TTI structure, the ACK/NACK is delivered in one of the three slots and the CQI in the remaining two slots.

Studies have been actively conducted on uplink communication systems like the HSDPA communication system for improving uplink communication efficiency. Currently an uplink communication system which enables uplink data transmission on an enhanced uplink dedicated channel (EUDCH) is being proposed. This EUDCH communication system still uses the schemes adopted in the HSDPA communication system. It adapts to AMC and HARQ. Also, the EUDCH communication system can use a short TTI of 2 ms (3 slots) similar to the HSDPA communication system. The TTI is a unit time period for which one coded block is transmitted. Downlink channel scheduling is carried out in a Node B, to thereby prevent scheduling-caused delay.

The EUDCH communication system transmits data on the uplink and needs HARQ for transmitted uplink data, as described above in the context of the HSDPA communication system. To support HARQ, the process of transmitting an ACK/NACK from a receiver to a transmitter is essential.

### SUMMARY OF THE INVENTION

An object of the present invention is to provide an apparatus and method for requesting uplink data retransmission in a CDMA communication system.

Another object of the present invention is to provide an apparatus and method for requesting uplink data retransmission by puncturing a data field of a DL DPCH in a CDMA communication system.

A further object of the present invention is to provide an apparatus and method for randomly determining a position to puncture in a data field of a DL DPCH in order to insert an uplink data retransmission request in the punctured position in a CDMA communication system.

Still another object of the present invention is to provide an apparatus and method for requesting uplink data transmission taking into consideration the compatibility with other systems in a CDMA communication system.

The above objects are achieved by providing an apparatus and method for transmitting/receiving an uplink data retransmission request.

According to one aspect of the present invention, in an apparatus for requesting uplink data retransmission in a CDMA communication system using a DL DPCH to which a DL DPCCH and a DL DPDCH are mapped, the DL DPCCH including a TPC field, a TFCI field, and a pilot field, and the DL DPDCH including first and second data fields for delivering downlink data, a puncturer generates a p-bit ACK or a p-bit NACK according to whether data received on an EUDCH is normal or abnormal, and punctures p bits in a position to transmit the ACK or NACK at in the first and second data fields of the DL DPDCH, determined under a predetermined control. A puncturing controller determines the position to transmit the ACK or NACK in the first and second data fields of the DL DPDCH. A DL DPCH transmitter inserts the ACK or NACK in the punctured bit positions and transmits the DL DPCH with the ACK or NACK.

According to another aspect of the present invention, in an apparatus for requesting uplink data retransmission in a CDMA communication system using a DL DPCH to which a DL DPCCH and a DL DPDCH are mapped, the DL DPCCH including a TPC field, a TFCI field, and a pilot field, and the DL DPDCH including first and second data fields for delivering downlink data, a DL DPCH receiver transmits data on an EUDCH and receives the DL DPCH signal. A puncturing controller determines a position to receive a p-bit ACK or a p-bit NACK in the first and second data fields of the DL DPDCH. A puncturer extracts p bits at the decided position as the ACK or NACK.

According to a further aspect of the present invention, in a method for requesting uplink data retransmission in a CDMA communication system using a DL DPCH to which a DL DPCCH and a DL DPDCH are mapped, the DL DPCCH including a TPC field, a TFCI field, and a pilot field, and the DL DPDCH including first and second data fields for delivering downlink data, data is received on an EUDCH, a p-bit ACK is generated if the received data is normal, and a p-bit NACK is generated if the received data is abnormal. A position to transmit the ACK or NACK is determined in the first and second data fields of the DL DPDCH. p bits are punctured in the decided position, the ACK or NACK is inserted in the punctured bit positions, and the DL DPCH with the ACK or NACK is transmitted.

According to still another aspect of the present invention, in a method for requesting uplink data retransmission in a CDMA communication system using a DL DPCH to which a DL DPCCH and a DL DPDCH are mapped, the DL DPCCH including a TPC field, a TFCI field, and a pilot field, and the DL DPDCH including first and second data fields for delivering downlink data, data is transmitted on an EUDCH, and the DL DPCH signal is received. A position to receive a p-bit ACK or a p-bit NACK is determined in the first and second data fields of the DL DPDCH. p bits are extracted from the decided position as the ACK or NACK.

According to yet another aspect of the present invention, in a method for requesting uplink data retransmission in a CDMA communication system using a downlink dedicated data channel for delivering downlink data, data is received on an uplink dedicated channel, a p-bit ACK is generated if the received data is normal, and a p-bit NACK is generated if the received data is abnormal. A position to transmit the ACK or NACK is determined in the downlink dedicated data channel. p bits are punctured in the decided position, the ACK or NACK is inserted in the punctured bit positions, and the downlink dedicated data channel with the ACK or NACK is transmitted.

### BRIEF DESCRIPTION OF THE DRAWINGS

FIG. 1 is a block diagram illustrating the configuration of a typical WCDMA communication system;

FIG. 2 is a diagram illustrating a signal flow for a data retransmission in an EUDCH communication system;

FIG. 3 is a block diagram illustrating the structure of a DL DPCH in the typical WCDMA communication system;

FIG. 4 is a block diagram illustrating the structure of a DL DPCH that delivers an ACK/NACK relating to uplink data according to an embodiment of the present invention;

FIG. 5 is a block diagram illustrating the structure of a DL DPCH that delivers an ACK/NACK relating to uplink data according to another embodiment of the present invention;

FIG. 6 is a block diagram of a Node B transmitter supporting the DL DPCH structure illustrated in FIG. 4;

FIG. 7 is a block diagram of a Node B transmitter supporting the DL DPCH structure illustrated in FIG. 5;

FIG. 8 is a block diagram of a UE receiver corresponding to the Node B transmitter illustrated in FIG. 6;

FIG. 9 is a block diagram of a UE receiver corresponding to the Node B transmitter illustrated in FIG. 7; and

FIG. 10 is a flowchart illustrating an operation for transmitting an ACK/NACK about uplink data according to the embodiments of the present invention.

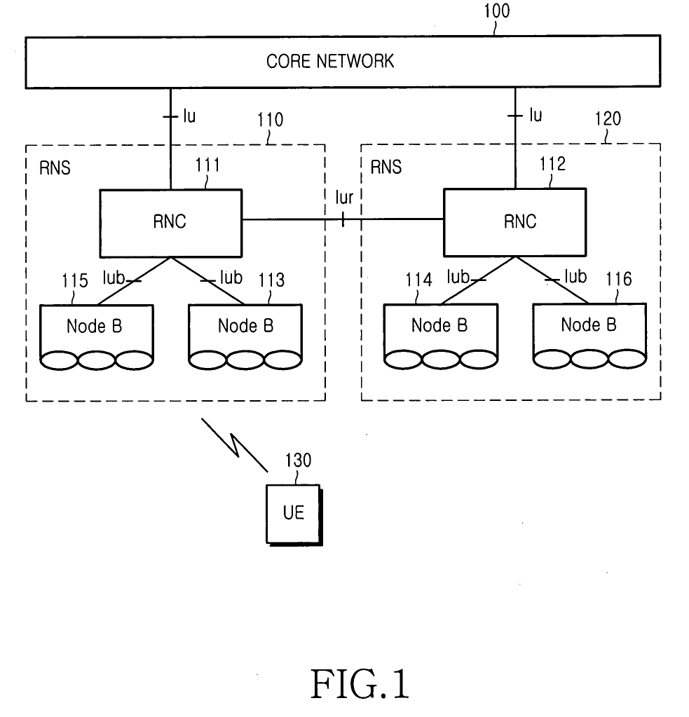

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

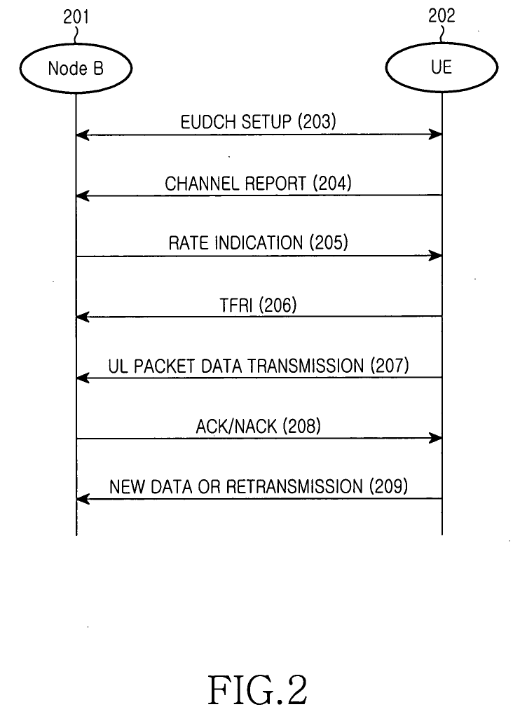

FIG. 2 is a diagram illustrating a signal flow for a data retransmission process in an EUDCH communication system.

The EUDCH communication system is being studied to determine methods to increase uplink communication efficiency. Uplink data transmission is carried out on an uplink channel, EUDCH. The EUDCH communication system can still use the schemes as adopted for the HSDPA communication system, as described before, i.e. It can use AMC and HARQ schemes.

Referring to FIG. 2, the EUDCH is set up between a Node B 201 and a UE 202 in step 203. The EUDCH setup is carried out by message transmission/reception on dedicated transport channels. In step 204, the UE 202 reports the channel condition of the EUDCH to the Node B 201 in step 204 (Channel Report). The channel condition can be represented by the EUDCH transmit power. The Node B 201 estimates the uplink channel condition of the UE 202 based on the reported channel condition information. If the channel condition information is the EUDCH transmit power, the Node B 201 can estimate the reception power of the EUDCH at the Node B 201 from the EUDCH transmit power. Thus, the Node B 201 estimates the current channel condition by comparing the EUDCH transmit power reported by the UE 202 to the reception power of the EUDCH measured at the Node B 201.

In step 205, the Node B 201 performs scheduling based on the estimated channel condition of the UE 202 and transmits the scheduling result to the UE 202 (Rate Indication). The scheduling refers to the process for selecting a UE to transmit packet data for the next TTI among a plurality of UEs communicating on the EUDCH within the same cell and determining a modulation scheme for the packet data, the number of codes to be assigned to the data transmission, and the data rate. In FIG. 2, the scheduling result indicates the data rate, by way of example. The UE 202 receives the scheduling result from the Node B 201 and transmits packet data based on the scheduling result. That is, the UE 202 generates a TFRI from the scheduling result and transmits the TFRI to the Node B 201 in step 206. The TFRI includes an orthogonal variable spreading factor (OVSF) code applied to the EUDCH, a modulation scheme, a data size, and HARQ information.

After transmitting the TFRI, the UE 202 determines the data rate of the packet data to be transmitted based on the TFRI and transmits the packet data at the determined data rate over the EUDCH to the Node B 201 in step 207 (UL Packet Data Transmission). The Node B 201 determines if the received packet data is normal. If the packet data is normal, the Node B 201 transmits an ACK to the UE 202. If the received data is abnormal, the Node B 201 transmits an NACK to the UE 202 in step 208. In the case of the ACK, the UE transmits the next packet data, while in the case of the NACK, the UE retransmits the transmitted packet data in step 209 (New Data or Retransmission). In either case, steps 204, 205 and 206 are repeated. As described before, the format of the retransmitted packet data is different depending on the soft combining scheme used to support the HARQ. If the EUDCH communication system employs the CC method, the initially transmitted packet data and the retransmitted packet data are in the same format. If the soft combining is the IR method, the initially transmitted packet data and the retransmitted packet data are in different formats. If the IR is self-decodable, namely partial IR, the initial transmission format is partially identical to the retransmission format. If the IR is non-self-decodable, namely full IR, the initial transmission format is entirely different from the retransmission format.

The Node B requests a retransmission of received uplink data, taking into consideration a channel condition to deliver the retransmitted data. The present invention proposes a method of transmitting an ACK/NACK related to the uplink data.

First, a novel downlink shared control channel can be defined as a channel to deliver the ACK/NACK.

In view of the nature of a shared channel, the use of the downlink shared control channel limits the number of UEs that can concurrently access the channel.

Secondly, a novel downlink dedicated control channel can be defined as a channel to deliver the ACK/NACK.

Compared to the downlink shared control channel, the downlink dedicated channel does not limit the number of UEs that can simultaneously access the channel. Despite this advantage, the use of the downlink dedicated channel may cause problems regarding compatibility with existing systems.

Thirdly, an existing downlink dedicated channel can be defined as a channel to deliver the ACK/NACK.

This method causes less problems regarding compatibility with the existing systems and does not limit the number of UEs that can simultaneously access the channel, which is encountered with the use of the downlink shared control channel.

The present invention provides the method of transmitting an ACK/NACK on the existing downlink dedicated channel.

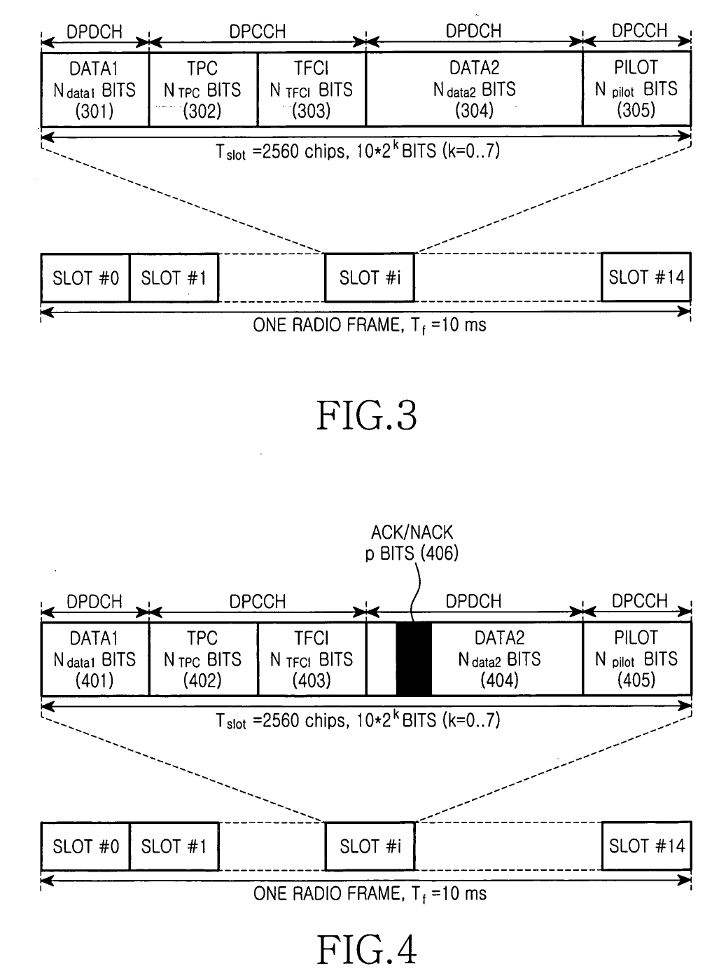

The structure of a DL DPCH (Downlink Dedicated Physical Control Channel) in the current WCDMA communication system will be described with reference to FIG. 3.

FIG. 3 is a diagram illustrating the structure of the DL DPCH in the typical WCDMA communication system.

Referring to FIG. 3, each DL DPCH frame includes 15 slots, slot#0 to slot#14. Each of the slots comprises a DPDCH (Dedicated Physical Data Channel) for delivering upper-layer data from a Node B to a UE, and a DPCCH (Dedicated Physical Control Channel) for transmitting a physical layer control signal. The DPCCH has a TPC (Transport Power Control) 302, a TFCI (Transport Format Combination Indicator) 303, and pilot bits 305. As illustrated in FIG. 3, each slot in one DL DPCH frame is 2,560 chips in length. Data 1 301 and Data 2 304 represent upper-layer data transmitted from the Node B to the UE on the DPDCH. The TPC 302 provides information for controlling the transmit power of the UE. The TFCI 303 indicates a TFC (Transport Format Combination) adopted by the downlink channel in the current frame (10 ms). Lastly, the pilot bits 305 provides a criterion by which the UE controls the transmit power of a DPCH. The information in the TFCI 303 is divided into a dynamic part and a semi-static part. There are TBS (Transport Block Size) and TBSS (Transport Block Set Size) in the dynamic part. The semi-static part provides information about TTI, channel coding scheme, coding rate, static rate matching, CRC size. Thus, the TFCI 303 indicates the number of transport blocks (TBs) on one channel frame and the number of TFCs available to each of the TBs.

With reference to FIG. 4, a description will be made of the structure of a DL DPCH for transmitting an ACK/NACK related to the uplink data according to an embodiment of the present invention.

FIG. 4 is a diagram illustrating the structure of a DL DPCH for transmitting an ACK/NACK related to the uplink data according to an embodiment of the present invention.

As described earlier, an ACK/NACK related to the uplink data must be transmitted to support HARQ in the EUDCH communication system. While the structure of an existing downlink dedicated channel is still used, predetermined bits of the DPDCH in the DL DPCH are punctured to transmit the ACK/NACK in the present invention.

As illustrated in FIG. 4, the DL DPCH comprises the DPDCH and the DPCCH. The DPDCH has Data 1 401 and Data 2 404, while the DPCCH has a TPC 402, a TFCI 403, and pilot bits 405. Data 1 401 and Data 2 404 are identical to Data 1 301 and Data 2 304 as illustrated in FIG. 3. The TPC 402, TFCI 403, and pilot 405 are identical to the TPC 302, TFCI 303 and pilot bits 305 as illustrated in FIG. 3, respectively. One thing to note herein is that the predetermined bits of a data field, for example, p bits of Data 2 404, are punctured and an ACK/NACK 406 related to the uplink data is inserted in the punctured p bits. The p-bit puncturing does not substantially affect the performance of data transmission on the DPDCH. However, if the punctured p-bit positions are fixed, the puncturing may deteriorate the data transmission performance. Thus, the positions of the p bits are randomly selected.

The bit positions of the DPDCH to be punctured to transmit the ACK/NACK are determined as in Equation 1 by
P(i)=rand(N_{data}−p+1)
where P(i) indicates the first bit position to be punctured in an ith slot, rand(x) is a function for generating a random variable in a range from 0 to x−1, N_{data} is the number of data bit positions in one DL DPCH slot, and p is the number of bits required to transmit the ACK/NACK. As noted from Equation (1), the ACK/NACK is transmitted in p successive bits randomly selected from a data field of one DL DPCH slot. That is, the bits of Data 1 401 and Data 2 404 in one DL DPCH slot are arranged together and sequentially numbered, starting with 0 for the first bit. Then p successive bits from the position calculated by Equation (1) are punctured and the ACK/NACK is transmitted in the punctured bit positions. Although the ACK/NACK can be represented in one bit, it occurs p times in each slot, that is, it is transmitted in p bits so as to increase radio transmission reliability. On the assumption that one TTI has N slots in the EUDCH communication system, p-bit ACK/NACK information can be transmitted in

$$\frac{p}{N}$$

bits per slot for N slots, or fully transmitted in one slot preset between the Node B and the UE in one TTI.

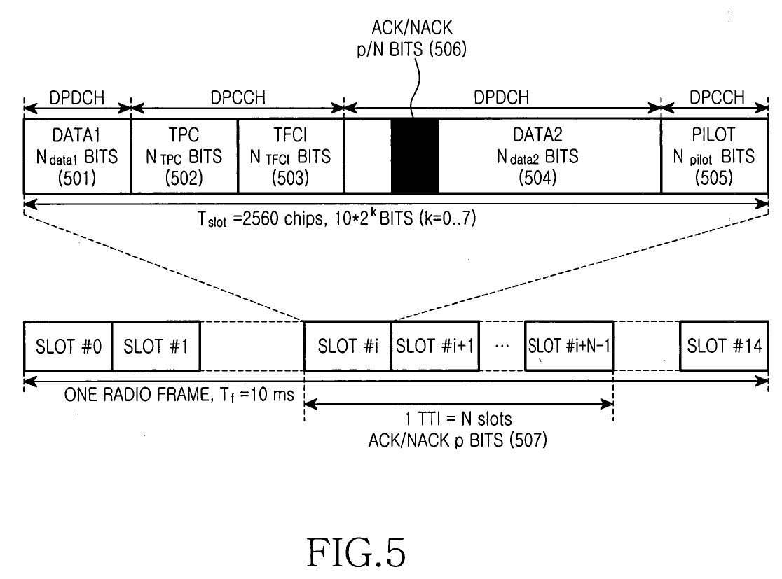

The case of repeating the ACK/NACK N times in each slot will be described with reference to FIG. 5.

FIG. 5 is a diagram illustrating the structure of a DL DPCH that delivers an ACK/NACK related to the uplink data according to another embodiment of the present invention.

An ACK/NACK transmission period is based on a scheduling period. A Node B transmits an ACK/NACK at least once within the scheduling period. Equation (1) applies to the case where an ACK/NACK is transmitted in each slot, whereas Equation (2) applies to the case where a p-bit ACK/NACK is transmitted through all of the slots of a TTI. In this case successive └p/N┘ bits are punctured and corresponding ACK/NACK is transmitted in each slot. And then for the last slot in the TTI, the remaining ACK/NACK is transmitted.

$$P ( i ) = \{ \begin{matrix}rand ( {N}_{data} - ⌊ p / N ⌋ + 1 ) , & n = 0 , 1 , … , N - 2 \\ rand ( {N}_{data} - ( p - ⌊ p / N ⌋ \times ( N - 1 ) ) + 1 ) , & n = N - 1 \end{matrix} \qquad ( 2 )$$

where P(i) indicates the first bit position to be punctured in an ith slot, └x┘ is a maximum natural number equal to or less than x, rand(x) is a function for generating a random variable in a range from 0 to x−1, N_{data} is the number of data bits in one DL DPCH slot, p is the number of bits required to transmit the ACK/NACK, n is a slot index in a TTI (0, 1, . . . , N−1), and N is the number of slots in one TTI. Here, n=i modulo N. Modulo is the remainder of a division. Uniformly distributed transmission of the ACK/NACK across all slots of a TTI according to Equation (2) improves transmission reliability.

The DL DPCH illustrated in FIG. 5 is configured to transmit the ACK/NACK in p/N bits per slot for N slots according to Equation (2) under the assumption that one TTI has N slots. For example, if the Node B schedules transmission based on a 3-slot TTI of 2 ms in the EUDCH communication system, the ACK/NACK must be transmitted at least once for each 2-ms TTI. Relying on Equation (1), the ACK/NACK is transmitted in p bits in each slot. Therefore, the ACK/NACK is 3 bits in total within one TTI. If the UE and the Node B agree that the ACK/NACK is to be transmitted in the first slot, the p-bit ACK/NACK is obviously transmitted in one TTI. On the other hand, if Equation (2) is used, the p-bit ACK/NACK is separately transmitted in p/3 bits per slot for the three slots of a TTI. Referring to Equation (1) and Equation (2), the ACK/NACK transmission can be correctly performed if the positions of the ACK/NACK are preset between the Node B and the UE.

Even though the UE transmits packet data on the EUDCH, the Node B may fail to receive the packet data. In this case, the Node B does not transmit an ACK/NACK on the DL DPCH. The Node B leaves the data of the DL DPCH unpunctured. The UE, however, awaits the ACK/NACK for the transmitted packet data and extracts actual data as the ACK/NACK, causing errors. To prevent these errors, the Node B punctures predetermined bits of the DL DPCH in DTX (Discontinuous Transmission) despite non-reception of packet data on the EUDCH in accordance with the present invention.

Equation (1) and Equation (2) have defined the rules of transmitting an ACK/NACK. Next, a detailed description will be made of how the Node B actually puncture P bit positions to transmit the ACK/NACK with reference to Equation (3) and Equation (4).

In general, Node Bs are asynchronous with each other in the WCDMA communication system. Hence, no timing synchronization is provided between them. Each Node B has its own timer and operates based on a reference timing counted by the timer. The timer counts in units of BFN (Node B Frame Number). Each Node B may cover a plurality of cells and each of the cells is provided with a timer operating with a predetermined offset from the BFN. The timer in the cell counts in units of SFN (System Frame Number). One SFN is 10 ms in duration and numbered between 0 and 4095. One SFN includes 38,400 chips. Hence, one chip is 10 ms/38,400 in duration. Using the SFN, each cell transmits an ACK/NACK in a different position from other cells within a data field of the DL DPCH, which can be expressed as Equation 3:
P(i)={SFN×15 slots+current_slot_number}mod(N_{data}−p+1) (3)
where P(i) is the first bit position to be punctured in an ith slot, mod represents the modulo operation, current_slot_number is the current slot index, SFN is the SFN of the current cell, N_{data} is the number of data bits in one DL DPCH slot, and p is the number of bits required to transmit the ACK/NACK.

{SFN×15 slots+current_slot_number} in Equation (3) is the SFN of the current cell expressed in terms of slots. The first position to insert the ACK/NACK in a field of the DL DPCH in the current slot is randomly decided by modulo-operating {SFN×15 slots+current _slot _number} with (N_{data}−p+1). The current slot index is known by counting the number of slots in the state where the UE acquires frame synchronization. The SFN can be replaced by CFN (Connection Frame Number). The CFN corresponds to a DPCH frame number, ranging from 0 to 255.

In the meantime, the ACK/NACK can be transmitted by being distributed across the slots of a TTI, as described earlier in connection with Equation (2). Then, Equation (3) is developed to Equation (4):
P(i)={SFN×15 slots+current_slot_number}mod(N_{data}−└p/N┘+1), n=0,1, . . . , N−2
P(i)={SFN×15 slots+current_slot_number}mod(N_{data}−(p−└P/N┘×(N−1))+1), n=N−1 (4)
where p is the number of bits required to transmit the ACK/NACK, N_{data} is the number of data bits in one DL DPCH slot, n is a slot index in a TTI (n=0, 1, . . . , N−1), and N is the number of slots in the TTI. Here, n=i mod N. The CFN can be used instead of the SFN, as described in connection with Eq. (3).

The SFN in Equation (3) and Equation (4) is different for each cell. Therefore, if the UE transmits uplink data on the same EUDCH in a soft handover zone, each cell places an ACK/NACK about the uplink data in a different position. As a result, the UE achieves diversity gain. As far as ‘a’ is an integer multiple of ‘b’ in an operation of ‘a mod b’, P(i) can be the same for each cell. This can be prevented by substituting the CFN for the SFN in Equation (3) and Equation (4) and assigning a different offset to each cell, thereby allowing each cell to position the ACK/NACK differently.

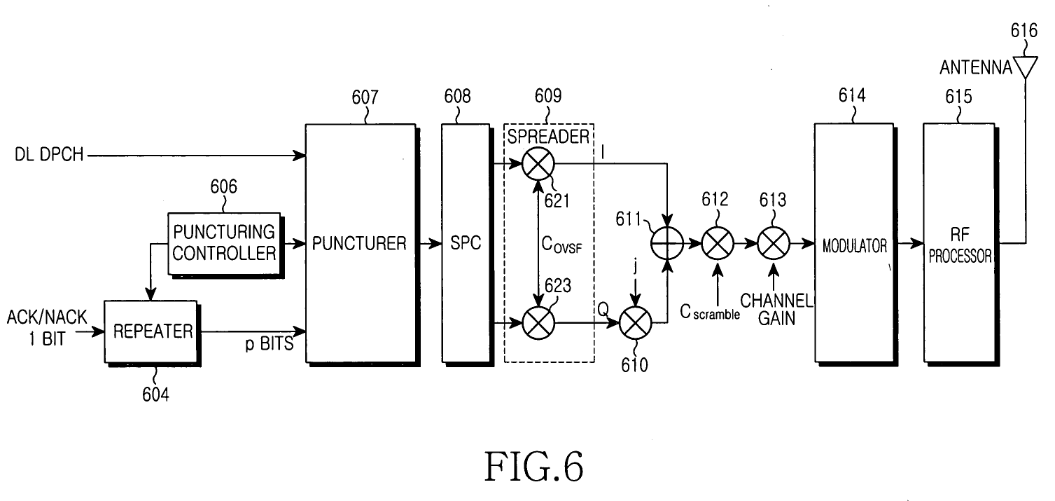

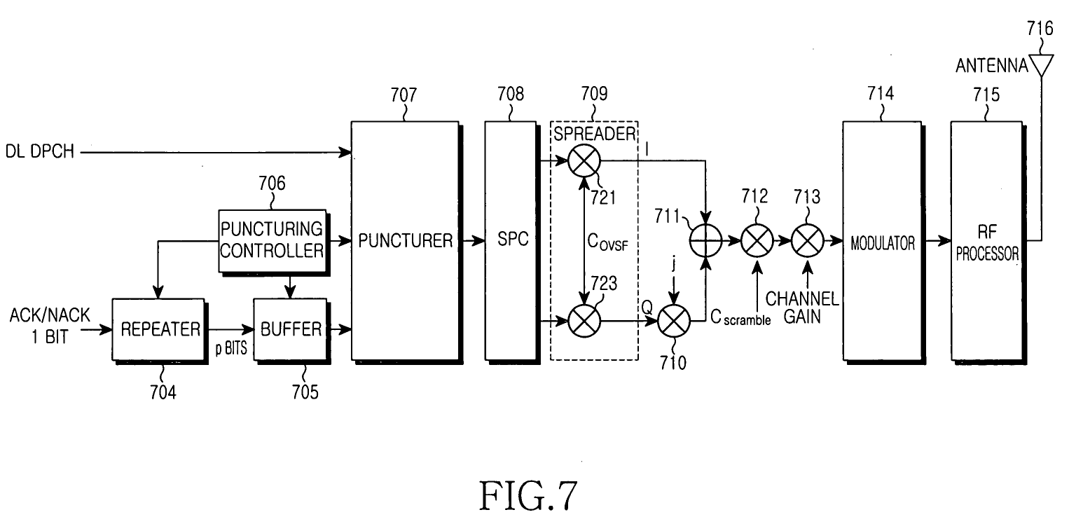

Now, the structure of a Node B transmitter according to the first embodiment of the present invention will be described with reference to FIG. 6.

FIG. 6 is a block diagram of a Node B transmitter supporting the DL DPCH structure illustrated in FIG. 4.

The illustrated Node B transmitter is configured to correspond with the DL DPCH that delivers a 1-bit ACK/NACK p times in one slot as illustrated in FIG. 4. For conciseness, only the DL DPCH will be considered in the Node B transmitter structure.

Referring to FIG. 6, a puncturing controller 606 in the Node B determines the positions to be punctured in the DL DPCH through an initial setup with a UE so that an ACK/NACK related to the uplink data received on the EUDCH from the UE can be inserted in the punctured positions. The puncturing controller 606 randomly determines the puncturing positions as described in connection with Equation (1) and Equation (3). Upon receipt of uplink data on the EUDCH from the UE, the Node B determines if the uplink data is normal and generates an ACK/NACK according to the determination. The ACK/NACK is represented in one bit and occurs p times to improve its transmission reliability. A repeater 604 repeats the 1-bit ACK/NACK to p bits and outputs the repeated ACK/NACK to a puncturer 607. A DL DPCH signal to be transmitted is also applied to the puncturer 607.

The puncturer 607 punctures the corresponding p bits in a data field of the DL DPCH under the control of the puncturing controller 606 and inserts the ACK/NACK received from the repeater 604 in the punctured p bit positions. A serial to parallel converter (SPC) 608 converts the signal received from the puncturer 607 to I and Q bit streams and outputs the bit streams to a spreader 609. The spreader 609 includes multipliers 621 and 623. The multiplier 621 multiplies the I bit stream by a spreading code C_{OVSF}, and the multiplier 623 multiplies the Q bit stream by the spreading code C_{OVSF}. The outputs of the multipliers 621 and 623 are fed to a summer 611 and a multiplier 610, respectively. The multiplier 610 converts the signal received from the multiplier 623 to an imaginary number component by multiplying the signal by a component j. The summer 611 sums the outputs of the multipliers 621 and 610 to a chip rate level complex signal. A multiplier 612, serving as a scrambler, multiplies the output of the summer 611 by a scrambling code C_{SCRAMBLE}. A multiplier 613 multiplies the scrambled signal by a predetermined channel gain. A modulator 614 modulates the output of the multiplier 613 in a predetermined modulation scheme. An RF processor 615 converts the modulated signal to an RF signal and transmits the RF signal in the air via an antenna 616.

With reference to FIG. 7, the structure of a Node B transmitter according to the second embodiment of the present invention will be described.

FIG. 7 is a block diagram of a Node B transmitter supporting the DL DPCH structure illustrated in FIG. 5.

The illustrated Node B transmitter is configured to correspond to the DL DPCH that delivers an ACK/NACK N times across the slots of one TTI as illustrated in FIG. 5. For conciseness, only the DL DPCH will be considered in the Node B transmitter structure.

Referring to FIG. 7, a puncturing controller 706 in the Node B determines the positions to be punctured in the DL DPCH through an initial setup with a UE so that an ACK/NACK related to the uplink data received on the EUDCH from a UE can be inserted in the punctured positions. The puncturing controller 706 randomly determines the puncturing positions as described in connection with Equation (2) and Equation (4). Upon receipt of uplink data on the EUDCH from the UE, the Node B determines if the uplink data is normal and generates an ACK/NACK according to the determination. The ACK/NACK is represented in one bit and repeated to p bits to improve its transmission reliability. A repeater 704 repeats the 1-bit ACK/NACK to p bits and outputs the repeated ACK/NACK to a buffer 705. The p-bit ACK/NACK is buffered because it is transmitted not in one slot at one time but distributedly in p/N bits per slot for N slots of a TTI (on the assumption that one TTI has N slots). Under the control of the puncturing controller 706, p/N bits of the p-bit ACK/NACK per slot are fed to a puncturer 707 at bit positions where the ACK/NACK is to be transmitted. A DL DPCH signal to be transmitted is also applied to the puncturer 707.

The puncturer 707 punctures the corresponding p/N bits in a data field of the DL DPCH under the control of the puncturing controller 706 and inserts the ACK/NACK received from the buffer 705 in the punctured p/N bit positions. An SPC 708 converts the signal received from the puncturer 707 to I and Q bit streams and outputs the bit streams to a spreader 709. The spreader 709 includes multipliers 721 and 723. The multiplier 721 multiplies the I bit stream by a spreading code C_{OVSF}, and the multiplier 723 multiplies the Q bit stream by the spreading code C_{OVSF}. The outputs of the multipliers 721 and 723 are fed to a summer 711 and a multiplier 610, respectively. The multiplier 710 converts the signal received from the multiplier 723 to an imaginary number component by multiplying the signal by a component j. The summer 711 sums the outputs of the multipliers 721 and 710 to a chip rate level complex signal. A multiplier 712, serving as a scrambler, multiplies the output of the summer 611 by a scrambling code C_{SCRAMBLE}. A multiplier 713 multiplies the scrambled signal by a predetermined channel gain. A modulator 714 modulates the output of the multiplier 713 in a predetermined modulation scheme. An RF processor 715 converts the modulated signal to an RF signal and transmits the RF signal in the air via an antenna 716.

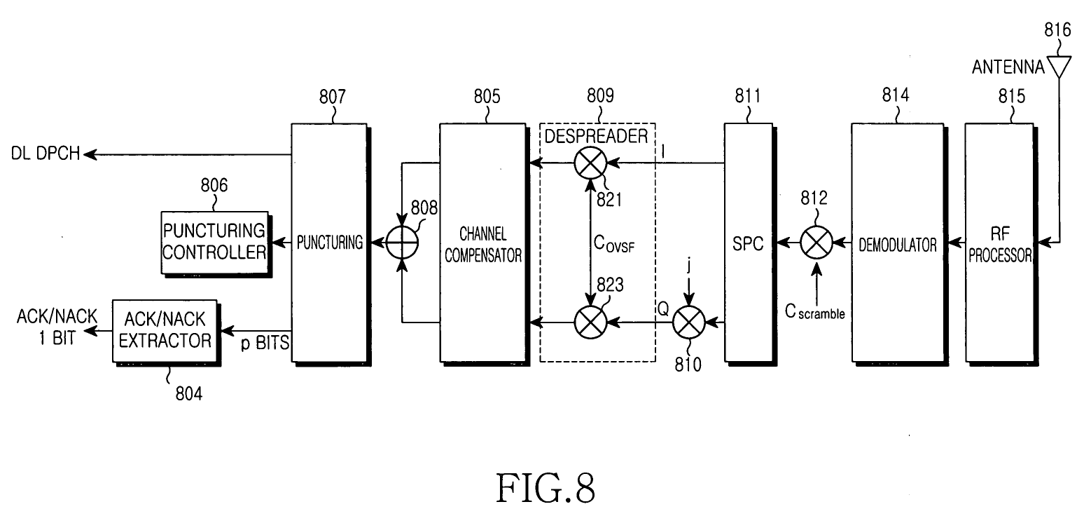

The structure of a UE receiver according to the first embodiment of the present invention will be described with reference to FIG. 8.

FIG. 8 is a block diagram of a UE receiver that corresponds to the Node. B transmitter illustrated in FIG. 6.

The illustrated UE receiver is configured to support the DL DPCH illustrated in FIG. 4 which delivers an ACK/NACK p times in one slot. Notably, the UE receiver structure as illustrated focuses only on the DL DPCH for conciseness.

Referring to FIG. 8, a signal received from the air via an antenna 816 is fed to an RF processor 815. The RF processor 815 downconverts the received signal to a baseband signal. A demodulator 814 demodulates the baseband signal in a demodulation scheme corresponding to the modulation scheme adopted in the Node B transmitter. A multiplier 812, functioning as a descrambler, multiplies the demodulated signal by a predetermined scrambling code, C_{SCRAMBLE}. An SPC 811 converts the descrambled signal to parallel I and Q bit streams. A despreader 809 has multipliers 821 and 823. The multiplier 821 multiplies the I bit stream by a spreading code C_{OVSF}, and the multiplier 823 multiplies the product of the Q bit stream and a j component, received from a multiplier 810, by the spreading code C_{OVSF}. A channel compensator 805 channel-compensates the spread signals received from the multipliers 821 and 823. A summer 808 sums the channel-compensated I and Q bit streams and feeds the sum to a puncturer 807.

Meanwhile, a puncturing controller 806 in the UE determines the positions inserted with an ACK/NACK relating to the uplink data transmitted on the EUDCH through an initial setup with the Node B. The puncturing controller 806 determines the randomly inserted positions as described in connection with Equation (1) and Equation (3). The puncturer 807 extracts the ACK/NACK from the inserted positions in the signal received from the summer 808, feeds the ACK/NACK to an ACK/NACK extractor 804, and outputs the remaining signal as a DL DPCH signal, under the control of the puncturing controller 806. The ACK/NACK extractor 804 converts the p-bit ACK/NACK to a 1-bit ACK/NACK.

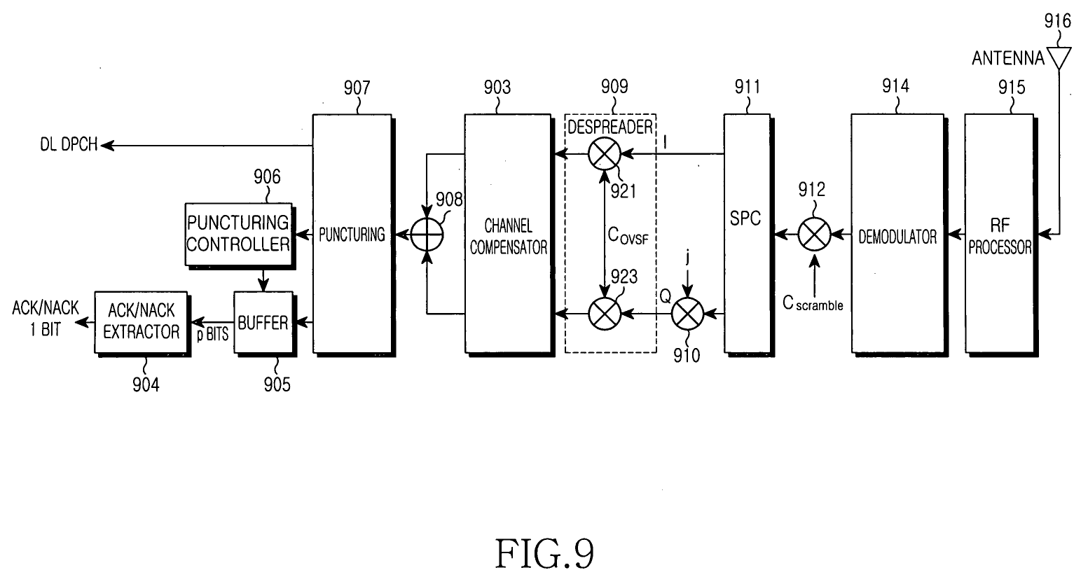

The structure of a UE receiver according to the second embodiment of the present invention will be described with reference to FIG. 9.

FIG. 9 is a block diagram of a UE receiver that corresponds to the Node B transmitter illustrated in FIG. 7.

The illustrated UE receiver is configured to support the DL DPCH illustrated in FIG. 5 which delivers an ACK/NACK N times across the slots of a TTI. Notably, the UE receiver structure as illustrated focuses only on the DL DPCH for conciseness.

Referring to FIG. 9, a signal received from the air via an antenna 916 is fed to an RF processor 915. The RF processor 915 downconverts the received signal to a baseband signal. A demodulator 914 demodulates the baseband signal in a demodulation scheme corresponding to the modulation scheme adopted in the Node B transmitter. A multiplier 912, functioning as a descrambler, multiplies the demodulated signal by a predetermined scrambling code, C_{SCRAMBLE}. An SPC 911 converts the descrambled signal to parallel I and Q bit streams. A despreader 909 has multipliers 921 and 923. The multiplier 921 multiplies the I bit stream by a spreading code C_{OVSF}, and the multiplier 923 multiplies the product of the Q bit stream and a j component, received from a multiplier 910, by the spreading code C_{OVSF}. A channel compensator 905 channel-compensates the spread signals received from the multipliers 921 and 923. A summer 908 sums the channel-compensated I and Q bit streams and feeds the sum to a puncturer 907.

Meanwhile, a puncturing controller 906 in the UE determines the positions inserted with an ACK/NACK relating to the uplink data transmitted on the EUDCH through an initial setup with the Node B. The puncturing controller 906 determines the randomly inserted positions as described in connection with Equation (2) and Equation (4). The puncturer 907 extracts the ACK/NACK from the inserted positions in the signal received from the summer 908, feeds the ACK/NACK to a buffer 905. The ACK/NACK is buffered because the Node B transmitter transmitted a p-bit ACK/NACK not in one slot at one time but distributedly in p/N bits per slot for N slots of a TTI (on the assumption that one TTI has N slots). Thus, the UE receiver buffers the p/N-bit ACK/NACK extracted from each of the N slots of the TTI N times at the buffer 905, outputs the extracted p-bit ACK/NACK to an ACK/NACK extractor 904, and outputs the remaining signal as the DL DPCH signal. The ACK/NACK extractor 904 converts the p-bit ACK/NACK to a 1-bit ACK/NACK.

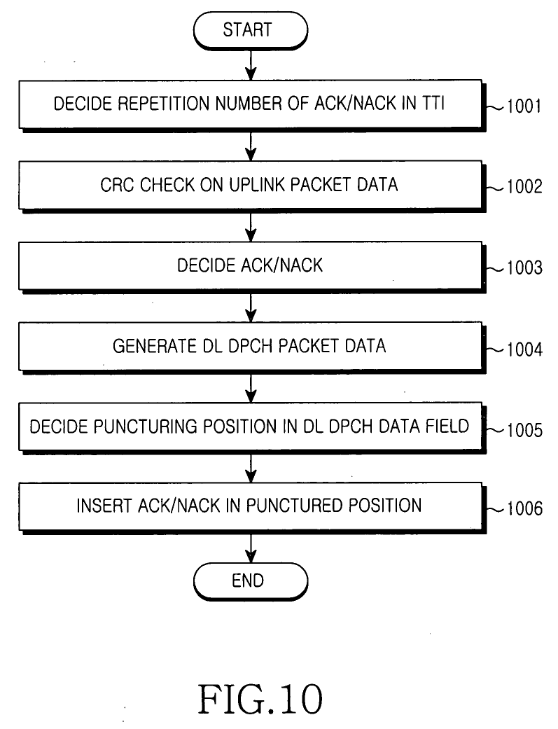

An operation for transmitting an ACK/NACK relating to the uplink data transmitted on the EUDCH will be described with reference to FIG. 10.

FIG. 10 is a flowchart illustrating an operation for transmitting an ACK/NACK relating to uplink data transmitted on the EUDCH according to the embodiments of the present invention.

Referring to FIG. 10, the Node B determines the number of transmission occurrences of an ACK/NACK about uplink data within one TTI through an initial setup with the UE in step 1001. Upon receipt of uplink packet data on the EUDCH, the Node B determines if the received packet data is normal in step 1002. The normal or abnormal reception is determined by a CRC check on the received packet data. If the CRC check result indicates no errors, the reception is considered normal, and if the CRC check indicates errors, the reception is considered abnormal. In step 1003, the Node B determines whether or not to transmit an ACK/NACK that relates to the uplink data according to the CRC check result.

The Node B generates a DL DPCH data packet to be transmitted in step 1004 and determines the positions in a data field of the DL DPCH in which the ACK/NACK is to be inserted in step 1005. The ACK/NACK positions are determined in one of the two methods expressed in Equation (1) to Equation (4). In step 1006, the Node B punctures the decided bit positions, inserts the ACK/NACK in the punctured bit positions, and transmits the DL DPCH with the ACK/NACK to the UE.

The inventive method of randomly determining the bit positions for an ACK/NACK is also applicable to other channels available in the EUDCH communication system. Also, the Node B may command the increase/decrease/maintenance of a maximum transmit power for the UE in the scheduling of step 205 shown in FIG. 2. This can be implemented by randomly puncturing a part of a DL DPCH data field similar to the random determination of the ACK/NACK positions.

In accordance with the present invention as described above, the puncturing of a data field of the existing DL DPCH and insertion of an ACK/NACK that relates to the uplink data in the punctured position in an EUDCH communication system ensures compatibility with other systems and supports HARQ for uplink data transmission.

While the invention has been shown and described with reference to certain preferred embodiments thereof, it will be understood by those skilled in the art that various changes in form and details may be made therein without departing from the spirit and scope of the invention as defined by the appended claims.

1. A method of requesting an uplink data retransmission in a CDMA (Code Division Multiple Access) communication system using a downlink dedicated physical channel (DL DPCH) to which a downlink dedicated physical control channel (DL DPCCH) and a downlink dedicated physical data channel (DL DPDCH) are mapped, the DL DPCCH having a transport power control (TPC) field, a transport format combination indicator (TFCI) field, and a pilot field, and the DL DPDCH having first and second data fields for delivering downlink data, comprising the steps of:
receiving data on an enhanced uplink dedicated channel (EUDCH), generating a p-bit acknowledgement (ACK) if the received data is normal, and generating a p-bit non-acknowledgement (NACK) if the received data is abnormal;
determining a bit position to transmit the ACK or NACK at in the first and second data fields of the DL DPDCH; and
puncturing p bits in the determined position, inserting the ACK or NACK in the punctured bit positions, and transmitting the DL DPCH with the ACK or NACK.

2. The method of claim 1, wherein the ACK or NACK is transmitted in one of N slots forming a transmit time interval (TTI) of the DL DPCH.

3. The method of claim 2, wherein the position to transmit the ACK or NACK at is randomly determined according to the number of data bits transmitted on the DL DPDCH and the number (p) of bits required to transmit the ACK or NACK.

4. The method of claim 2, wherein the position to transmit the ACK or NACK is determined by
P(i)=rand(N_{data}−p+1)
where P(i) indicates a position to transmit the ACK/NACK in an ith slot, N_{data} is the number of data bits in one DL DPCH slot, p is the number of bits required to transmit the ACK/NACK, and rand(x) is a function for generating a random variable in a range from 0 to x−1.

5. The method of claim 2, wherein the position to transmit the ACK or NACK at is determined randomly based on a system frame number (SFN), a DL DPCH slot index, the number of data bits transmitted on the DL DPDCH, and the number (p) of bits required to transmit the ACK or NACK.

6. The method of claim 2, wherein the position to transmit the ACK or NACK at is determined by
P(i)={SFN×15 slots+current_slot_number}mod(N_{data}−p+1)
where P(i) indicates a position to transmit the ACK/NACK in an ith slot, current_slot_number is a current slot index of the DL DPCH, SFN is the SFN of a current cell, N_{data} is the number of data bits in one DL DPCH slot, and p is the number of bits required to transmit the ACK/NACK.

7. The method of claim 1, wherein the ACK or NACK is transmitted distributed across N slots forming a TTI of the DL DPCH.

8. The method of claim 7, wherein the position to transmit the ACK or NACK at is determined randomly based on the number of data bits transmitted on the DL DPDCH, the number (p) of bits required to transmit the ACK or NACK, and the number (N) of slots included in the TTI.

9. The method of claim 7, wherein the position to transmit the ACK or NACK at is determined by
$$P ( i ) = \{ \begin{matrix}rand ( {N}_{data} - ⌊ p / N ⌋ + 1 ) , & n = 0 , 1 , … , N - 2 \\ rand ( {N}_{data} - ( p - ⌊ p / N ⌋ \times ( N - 1 ) ) + 1 ) , & n = N - 1 \end{matrix}$$
where P(i) indicates a position to transmit the ACK or NACK in an ith slot, └x┘ is a maximum natural number equal to or less than x, N_{data} is the number of data bits in one DL DPCH slot, p is the number of bits required to transmit the ACK/NACK, rand(x) is a function for generating a random variable in a range from 0 to x−1, n is a slot index in a TTI (n=0, 1, . . . , N−1), N is the number of slots in one TTI. and n=i modulo N, modulo being an operation that computes the remainder of a division.

10. The method of claim 7, wherein the position to transmit the ACK or NACK at is determined by
P(i)={SFN×15 slots+current_slot_number}mod(N_{data}−└p/N┘+1), n=0,1, . . . , N−2
P(i)={SFN×15 slots+current_slot_number}mod(N_{data}−(p−└p/N┘×(N−1))+1), n=N−1
where P(i) indicates a position to transmit the ACK/NACK in an ith slot, current_slot_number is a current slot index of the DL DPCH, SFN is the SFN of a current cell, N_{data} is the number of data bits in one DL DPCH slot, p is the number of bits required to transmit the ACK/NACK, n is a slot index in a TTI (n=0, 1, . . . , N−1), N is the number of slots in one TTI, and n=i modulo N, modulo being an operation that computes the remainder of a division.

11. An apparatus for requesting an uplink data retransmission in a CDMA (Code Division Multiple Access) communication system using a downlink dedicated physical channel (DL DPCH) to which a downlink dedicated physical control channel (DL DPCCH) and a downlink dedicated physical data channel (DL DPDCH) are mapped, the DL DPCCH having a transport power control (TPC) field, a transport format combination indicator (TFCI) field, and a pilot field, and the DL DPDCH having first and second data fields for delivering downlink data, comprising:
a puncturer for generating a p-bit acknowledgement (ACK) if data received on an enhanced uplink dedicated channel (EUDCH) is normal or a p-bit non-acknowledgement (NACK) if data received on the EUDCH is abnormal, and puncturing p bits in a position to transmit the ACK or NACK in the first and second data fields of the DL DPDCH, said position determined under a predetermined control;
a puncturing controller for determining the position to transmit the ACK or NACK in the first and second data fields of the DL DPDCH; and
a DL DPCH transmitter for inserting the ACK or NACK in the punctured bit positions and transmitting the DL DPCH with the ACK or NACK.

12. The apparatus of claim 11, wherein the puncturing controller determines the puncturing position for the ACK or NACK so that the ACK or NACK is transmitted in one of N slots forming a transmit time interval (TTI) of the DL DPCH.

13. The apparatus of claim 12, wherein the puncturing controller determines the puncturing position for the ACK or NACK randomly according to the number of data bits transmitted on the DL DPDCH and the number (p) of bits required to transmit the ACK or NACK.

14. The apparatus of claim 12, wherein the puncturing controller determines the puncturing position for the ACK or NACK by
P(i)=rand(N_{data}−p+1)
where P(i) indicates a position to transmit the ACK/NACK in an ith slot, N_{data} is the number of data bits in one DL DPCH slot, p is the number of bits required to transmit the ACK/NACK, and rand(x) is a function for generating a random variable in a range from 0 to x−1.

15. The apparatus of claim 12, wherein the puncturing controller determines the puncturing position for the ACK or NACK randomly based on a system frame number (SFN), a DL DPCH slot index, the number of data bits transmitted on the DL DPDCH, and the number (p) of bits required to transmit the ACK or NACK.

16. The apparatus of claim 12, wherein the puncturing controller determines the puncturing position for the ACK or NACK by
P(i)={SFN×15 slots+current_slot_number}mod(N_{data}−p+1)
where P(i) indicates a position to transmit the ACK/NACK in an ith slot, current_slot_number is a current slot index of the DL DPCH, SFN is the SFN of a current cell, N_{data} is the number of data bits in one DL DPCH slot, and p is the number of bits required to transmit the ACK/NACK.

17. The apparatus of claim 11, wherein the puncturing controller determines the puncturing position for the ACK or NACK so that the ACK or NACK is transmitted distributedly across N slots forming a TTI of the DL DPCH.

18. The apparatus of claim 17, wherein the puncturing controller determines the puncturing position for the ACK or NACK randomly based on the number of data bits transmitted on the DL DPDCH, the number (p) of bits required to transmit the ACK or NACK, and the number (N) of slots included in the TTI.

19. The apparatus of claim 17, wherein the position to transmit the ACK or NACK at is determined by
$$P ( i ) = \{ \begin{matrix}rand ( {N}_{data} - ⌊ p / N ⌋ + 1 ) , & n = 0 , 1 , … , N - 2 \\ rand ( {N}_{data} - ( p - ⌊ p / N ⌋ \times ( N - 1 ) ) + 1 ) , & n = N - 1 \end{matrix}$$
where P(i) indicates a position to transmit the ACK or NACK at in an ith slot, └x┘ is a maximum natural number equal to or less than x, N_{data} is the number of data bits in one DL DPCH slot, p is the number of bits required to transmit the ACK/NACK, rand(x) is a function for generating a random variable in a range from 0 to x−1, n is a slot index in a TTI (n=0, 1, . . . , N−1), N is the number of slots in one TTI, and n=i modulo N, modulo being an operation that computes the remainder of a division.

20. The apparatus of claim 17, wherein the puncturing controller determines the puncturing position for the ACK or NACK by
P(i)={SFN×15 slots+current_slot_number}mod(N_{data}−└p/N┘+1), n=0,1, . . . , N−2
P(i)={SFN×15 slots+current_slot_number}mod(N_{data}−(p−└p/N┘×(N−1))+1), n=N−1
where P(i) indicates a position to transmit the ACK/NACK in an ith slot, current_slot_number is a current slot index of the DL DPCH, SFN is the SFN of a current cell, N_{data} is the number of data bits in one DL DPCH slot, p is the number of bits required to transmit the ACK/NACK, n is a slot index in a TTI (n=0, 1, . . . , N−1), N is the number of slots in one TTI, and n=i modulo N, modulo being an operation that computes the remainder of a division.

21. A method of receiving an uplink data retransmission request in a CDMA (Code Division Multiple Access) communication system using a downlink dedicated physical channel (DL DPCH) to which a downlink dedicated physical control channel (DL DPCCH) and a downlink dedicated physical data channel (DL DPDCH) are mapped, the DL DPCCH having a transport power control (TPC) field, a transport format combination indicator (TFCI) field, and a pilot field, and the DL DPDCH having first and second data fields for delivering downlink data, comprising the steps of:
transmitting data on an enhanced uplink dedicated channel (EUDCH), and receiving a DL DPCH signal;
determining a position to receive a p-bit acknowledgement (ACK) or a p-bit non-acknowledgement (NACK) in the first and second data fields of the DL DPDCH; and
extracting p bits at the determined position as the ACK or NACK.

22. The method of claim 21, wherein the ACK or NACK is received in one of N slots forming a transmit time interval (TTI) of the DL DPCH.

23. The method of claim 22, wherein the position to receive the ACK or NACK at is determined randomly based on the number of data bits transmitted on the DL DPDCH and the number (p) of bits required to represent the ACK or NACK.

24. The method of claim 21, wherein the ACK or NACK is received distributed across N slots forming a TTI of the DL DPCH.

25. The method of claim 24, wherein the position to receive the ACK or NACK at is determined randomly based on the number of data bits transmitted on the DL DPDCH, the number (p) of bits required to represent the ACK or NACK, and the number (N) of slots included in the TTI.

26. An apparatus for receiving an uplink data retransmission request in a CDMA (Code Division Multiple Access) communication system using a downlink dedicated physical channel (DL DPCH) to which a downlink dedicated physical control channel (DL DPCCH) and a downlink dedicated physical data channel (DL DPDCH) are mapped, the DL DPCCH having a transport power control (TPC) field, a transport format combination indicator (TFCI) field, and a pilot field, and the DL DPDCH having first and second data fields for delivering downlink data, comprising the steps of:
a DL DPCH receiver for transmitting data on an enhanced uplink dedicated channel (EUDCH), and receiving a DL DPCH signal;
a puncturing controller for determining a position to receive a p-bit acknowledgement (ACK) or a p-bit non-acknowledgement (NACK) in the first and second data fields of the DL DPDCH; and
a puncturer for extracting p bits at the determined position as the ACK or NACK.

27. The apparatus of claim 26, wherein the ACK or NACK is received in one of N slots forming a transmit time interval (TTI) of the DL DPCH.

28. The apparatus of claim 27, wherein the puncturing controller determines the position to receive the ACK or NACK randomly based on the number of data bits transmitted on the DL DPDCH and the number (p) of bits required to represent the ACK or NACK.

29. The apparatus of claim 25, wherein the ACK or NACK is received distributed across N slots forming a TTI of the DL DPCH.

30. The apparatus of claim 29, wherein the puncturing controller determines the position to receive the ACK or NACK randomly based on the number of data bits transmitted on the DL DPDCH, the number (p) of bits required to represent the ACK or NACK, and the number (N) of slots included in the TTI.

31. A method of requesting an uplink data retransmission in a CDMA (Code Division Multiple Access) communication system using a downlink dedicated data channel for delivering downlink data, comprising the steps of:
receiving data on an uplink dedicated channel, generating a p-bit acknowledgement (ACK) if the received data is normal, and generating a p-bit non-acknowledgement (NACK) if the received data is abnormal;
determining a position to transmit the ACK or NACK in the downlink dedicated data channel; and
puncturing p bits in the determined position, inserting the ACK or NACK in the punctured bit positions, and transmitting the downlink dedicated data channel with the ACK or NACK.

32. The method of claim 31, wherein the ACK or NACK is transmitted in one of N slots forming a transmit time interval (TTI) of the downlink dedicated data channel.

33. The method of claim 32, wherein the position to transmit the ACK or NACK at is determined randomly based on the number of data bits transmitted on the downlink dedicated data channel and the number (p) of bits required to transmit the ACK or NACK.

34. The method of claim 32, wherein the position to transmit the ACK or NACK at is determined randomly based on a system frame number (SFN), a slot index of the dedicated physical channel, the number of data bits transmitted on the dedicated physical channel, and the number (p) of bits required to transmit the ACK or NACK.

35. The method of claim 31, wherein the ACK or NACK is transmitted distributed across N slots forming a TTI of the downlink dedicated data channel.

36. The method of claim 35, wherein the position to transmit the ACK or NACK at is determined randomly based on the number of data bits transmitted on the downlink dedicated data channel, the number (p) of bits required to transmit the ACK or NACK, and the number (N) of slots included in the TTI.

37. The method of claim 2, wherein the position to transmit the ACK or NACK at is determined randomly based on a connection frame number (CFN), a slot index of the DL DPCH, the number of data bits transmitted on the DL DPDCH, and the number (p) of bits required to transmit the ACK or NACK.

38. The apparatus of claim 12, wherein the puncturing controller determines the position to transmit the ACK or NACK randomly based on a CFN, a slot index of the DL DPCH, the number of data bits transmitted on the DL DPDCH, and the number (p) of bits required to transmit the ACK or NACK.

39. The method of claim 32, wherein the puncturing controller determines the position to transmit the ACK or NACK randomly based on a CFN, a slot index of the dedicated physical channel, the number of data bits transmitted on the dedicated physical data channel, and the number (p) of bits required to transmit the ACK or NACK.

40. The method of claim 6, wherein the SFN is set to a different value for each cell.

41. The method of claim 37, wherein the CFN is set to a different value for each cell by assigning a different offset to the cell.

42. The apparatus of claim 16, wherein the SFN is set to a different value for each cell.

43. The apparatus of claim 38, wherein the CFN is set to a different value for each cell by assigning a different offset to the cell.

44. The method of claim 10, wherein the SFN is set to a different value for each cell.

45. The apparatus of claim 20, wherein the SFN is set to a different value for each cell.

46. The method of claim 39, wherein the CFN is set to a different value for each cell by assigning a different offset to the cell.
